(19) United States
(12) Patent Application Publication
(10) Pub. No.: US 2014/0042782 A1
(43) Pub. Date: Feb. 13, 2014

(54) Retractable car seat sunshade

(71) Applicant: Robin Lapointe, Dollard des Ormeaux (CA)

(72) Inventor: Robin Lapointe, Dollard des Ormeaux (CA)

(21) Appl. No.: 13/654,384

(22) Filed: Oct. 17, 2012

Related U.S. Application Data
(60) Provisional application No. 61/628,789, filed on Nov. 7, 2011.

(51) Int. Cl. A47C 29/00; B60N 2/26

(52) U.S. Cl. 297/184.13

(57) ABSTRACT

An improved child car seat, sun-protecting system, in which is retractable and adaptable. This novel car seat sunshade can attach to any type of child car seat or high back booster seat. This car seat sunshade retracts when it's not in use, and extends out when needed. With its compact design, it can still fully retract even with a vehicle incorporating rear seat headrests. It has its own self-supporting frame and changeable sunshade panels to better suite the child's sun shading requirements. These different size removable and changeable sunshade panels are also adjustable in height and could double the child's sun block protection. The front panel is height adjustable to protect the child's eyes from the sun entering the front windshield of the vehicle. This car seat sunshade has an adjustable top opening to increase the sunshades top ventilation and the child's overhead visibility. It's easy to install and is buckled and secured to the car seat by just one strap. Also since this sunshade is independent to the car seat, as the child grows, this sunshade can be raised as required above the child head.

### CROSS REFERENCE TO RELATED APPLICATIONS

This application is a non-provisional application of Applicant's provisional Application Ser. No. 61/628,789 filed on Nov. 11, 2011.

### BACKGROUND OF INVENTION

Existing child car sunshade products have several problems in which limits there usage or accessibility. The most common style today are shade panels which attaches to the vehicle windows, thus reducing the drivers, passengers and child's outside visibility. These types of sun shades often incorporates window suction cups in which many times do not stick well and do fall off in time with changes in temperature and movement etc. Also these window shades do not allow the occupant to roll down their window and tend to flop around and could fall off due to the airflow from an open window. At night or in low light conditions, these side and rear window shades should be removed or they could be dangerous, as they will reduce the driver's visibility.

There are also slide on door window shades that are like a nylon sock in which slips over the door window creating the same problems as mentioned above.

Also there are stick on window tint shade products, in which are difficult to remove and/or replace on. Many of these products do recommend that you do not operate your window due to the possibility of this window tint being accidently removed by the door window seal. Also at night, this window tint will reduce the driver's visibility. Many places today do have maximum window tint Laws, and with many vehicle windows being already tinted, this additional window tint could surpass this legal limit.

Then there are the traditional child shading techniques such as moving the child car seat from one side of the car to the other depending the sun direction, but unfortunately the roads do change direction, thus the protection is minimal. Some people use sun hats, but these hats do not always protect the child's eyes or the rest of their body.

Some people use blankets as a sunshade, clamping it in-between the window glass and the doorframe and drooping it over the child car seat. This method prevents one from rolling down their window, and does hinder the rest of the passenger's space and outside visibility.

With this all being said, its far better for the driver and the vehicle occupants not to have sun shades on the car windows, and to have it mounted near or onto the child's car seat itself.

There has been many attempts to make the ideal car seat sunshade, but they all fall short by either there lack of rigidity, functionality, retract ability or versatility. For example in U.S. Pat. No. 5,553,914 to Holladay. This seat shade does attached fixed to a child's car seat with its own internal frame. This frame must be screwed to the car seat, thus making it non transferable between other car seats and only provides minimal sun top protection. In the U.S. Pat. No. 5,538,319 to DiMurro. Here this sun shade does have a fixed wire frame and can not retract for easy removal of the child, and how it hooks on to the car seat will not suite all types of car seats or any high booster seats as well. Another design is the U.S. Pat. No. 6,908,148 to Wang. Here is basically a zipper in container that fits over and around a car seat. It's not retractable, and does not use a frame. It could be difficult to remove the child from the car seat and limits the child accessibility. The child could also feel too enclosed, and not suited for high booster seats or for kids that need the space to move around or to play with toys in.

There are several car seat sunshade designs, and they all fall short due to their construction and function ability. Many of these car seat sunshades tuck in between the back of the child's car seat and the vehicles rear seat. This method of securing it is faulty, since there is no positive attachment between the two in case of a car accident. These sunshades could cause a loose fit in between the vehicle and child's car seat caused by the child touching or playing with the sunshade; or by some car seats having a curved seat back; or with aggressive driving and/or driving on bumpy roads. There is a need today to have a fully retractable sunshade in which suites all types of children car seats and high booster seats designs, with its own self supporting frame and not depending on the car seat itself. Also this sunshade should be securely attached to the car seat and quickly and easily adaptable for the child's height and sun blocking requirements.

Also many vehicles today incorporate built in rear seat head rests in which hinder many types of car seat sunshades from folding backwards. Today's sunshades must be adaptable for this problem.

The foregoing has outlined some of the more pertinent objects of the invention. These objects should be construed to be merely illustrative of some of the more prominent features and applications of the intended invention. Applying the disclosed invention in a different manner of by modifying the invention within the scope of this disclosure can attain many other beneficial results. Accordingly, other objects and a fuller understanding of the invention may be had by referring to the summary of the invention and the detailed description of the preferred embodiment in addition to the scope of the invention defined by the claims taken in conjunction with the accompanying drawings.

### BRIEF SUMMARY OF THE INVENTION

Accordingly, the after mentioned problems and difficulties are obviated by the present invention. This novel car seat sunshade system folds away to easily place or to remove the child from the car seat with out removing it or tilting the child forward. This sunshade attaches securely with a latching strap and can attach to any baby car seat or high back booster seat. It's fully adjustable and adaptable for the child's height and for the ever-changing child's sun protection requirements.

Therefore it's among the primary objectives of this invention to have it's own self-supporting retractable frame.

A second object of this invention is to be able to attach it rigidly to the back of an existing child car seat or high back booster seat, securing it with just one latching adjustable strap.

A third object of this invention is to have removable side and front sunshade panels to better accommodate for the child's height and sun blocking requirements.

A fourth objective of this invention is to have the side and front sun shade panels adjustable as they could be raised and lowered, and also doubled over to double the sun blocking effectiveness.

A fifth object of this sunshade is having an adjustable top opening in order to adjust the sun shade ventilation or to allow the child to have better upwards visibility from with in.

A sixth objective is for the sunshade frame to be attached firmly to the child car seat, so then when this seat is removed, the sunshade will be removed with it as well.

A seventh objective is for this sunshade to be able to fully retract and to close even if there is a vehicle rear seat headrest.

Another object is for the sunshade cover to be easily removed from its frame for cleaning purposes.

Still another objective of this invention is to be able to adjust the height of this sunshade frame regardless of the actual height of the child car seat.

A last objective is to be as compact as possible in its retracted position, and also in its open position to help minimise the drivers rear blind spots.

### BRIEF DESCRIPTION OF THE DRAWINGS

The features of the present invention which are believed to be novel are set forth with particularity in the appended claims. The present invention, with respect to its organization and manner of operation, together with further objects and advantages thereof, may be best be understood by reference to the following description, taken in connection with the accompanying drawings in which:

FIG. 1A. is a general isometric front side view of the sunshade in its open position.

FIG. 1B. is a prospective view of the sunshade in its closed, retracted position.

FIG. 1C. is a prospective view of the sunshade frame support arms being extended outwards into its open position.

FIG. 1D. is a view showing the sunshade top panel in its open position with its side and front panel in its up position.

FIG. 2A. is a prospective view showing the sunshade front panel in its down position.

FIG. 2B. showing the sunshade one side panel in its down position.

FIG. 2C. is a view showing both side and front panel in its down position.

FIG. 3. is a prospective view showing the front panel in its half way down position along with its right side panel folded half way up.

FIG. 4. shows the sunshade zipper version with its top sun-vent flap open and with its front and short side panels down.

FIG. 5. is showing how the sunshade front and side panels are removable and with its sun-vent cover in its closed position.

FIG. 6. shows the sunshade with its front panel removed and with its sun-vent cover partly open.

FIG. 7A. showing a rear prospective view of how the sunshade frame attaches to the car seat.

FIG. 7B. is an isometric view showing the sunshade frame.

FIG. 7C. is a rear prospective view of the sunshade frame being attached to a curved back surface of a car seat.

FIG. 8A. is a rear prospective view showing the sunshade mounted higher than the seat back of a high booster seat.

FIG. 8B. is a detailed view showing an adjustable height finger, and how it rests on the top of the car seat or high booster seat.

FIG. 9A. is a view showing how the top panel attaches to the sunshade frame.

FIG. 9B. shows a side view of FIG. 9A. showing how the top panel is placed down over the support arms.

FIG. 10. is a prospective view showing how the cross bar could be slid into a sewn pocket with in the top panel.

FIG. 11. shows another method of sliding the cross bar side holes with in the ends of the support bars.

FIG. 12A. is an isometric view showing a method of how the support arms pivot outwards and then drop into a pocket to lock them in place.

FIG. 12B. is a detailed view showing the support arm in its locked open position.

FIG. 13. shows a swing up support arm version.

FIG. 14. shows a telescoping, swing up support arm version.

FIG. 15A. shows a side view of the placement of the car seat with in the car, with the sunshade in its retracted, closed position.

FIG. 15B. shows the same view as FIG. 15A, however with the sunshade in its extended, open position.

FIG. 16. shows a side view of a car seat with the sunshade in its closed, retracted position, and how it fits with a typical rear seat headrest.

FIG. 17. is a view of this sunshade as a spring roller shade design.

FIG. 18A. is a folded shade version of this sunshade design in its folded closed position.

FIG. 18B. is the same view as in FIG. 18A, except with the folded shade in its open position.

### DETAILED DESCRIPTION OF THE INVENTION

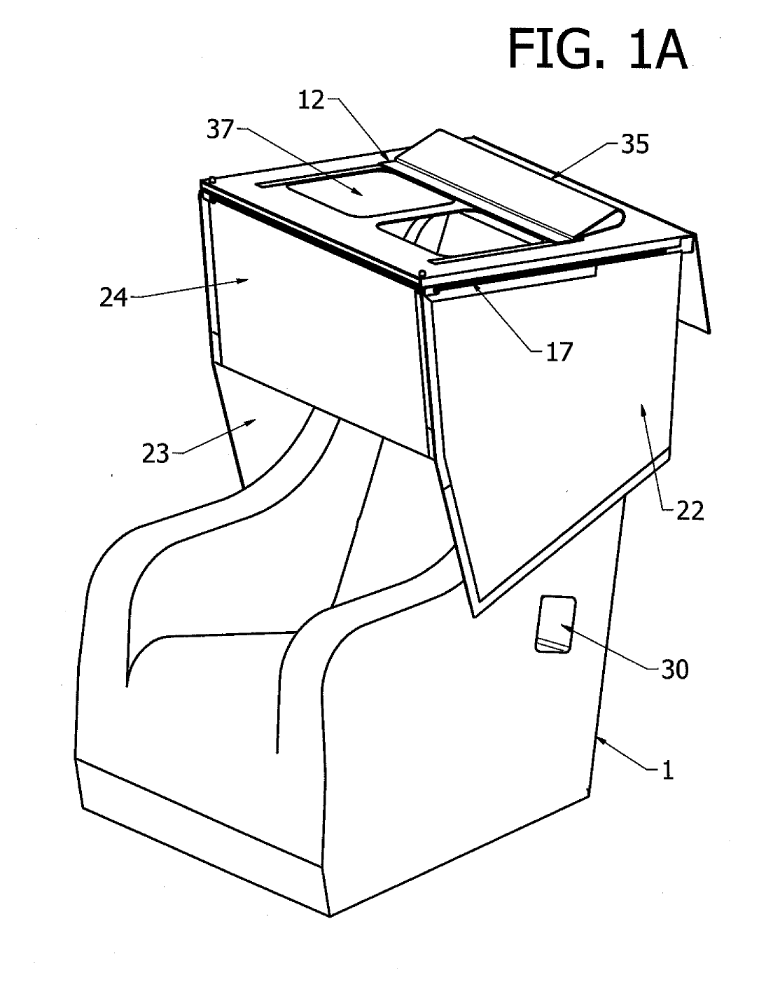

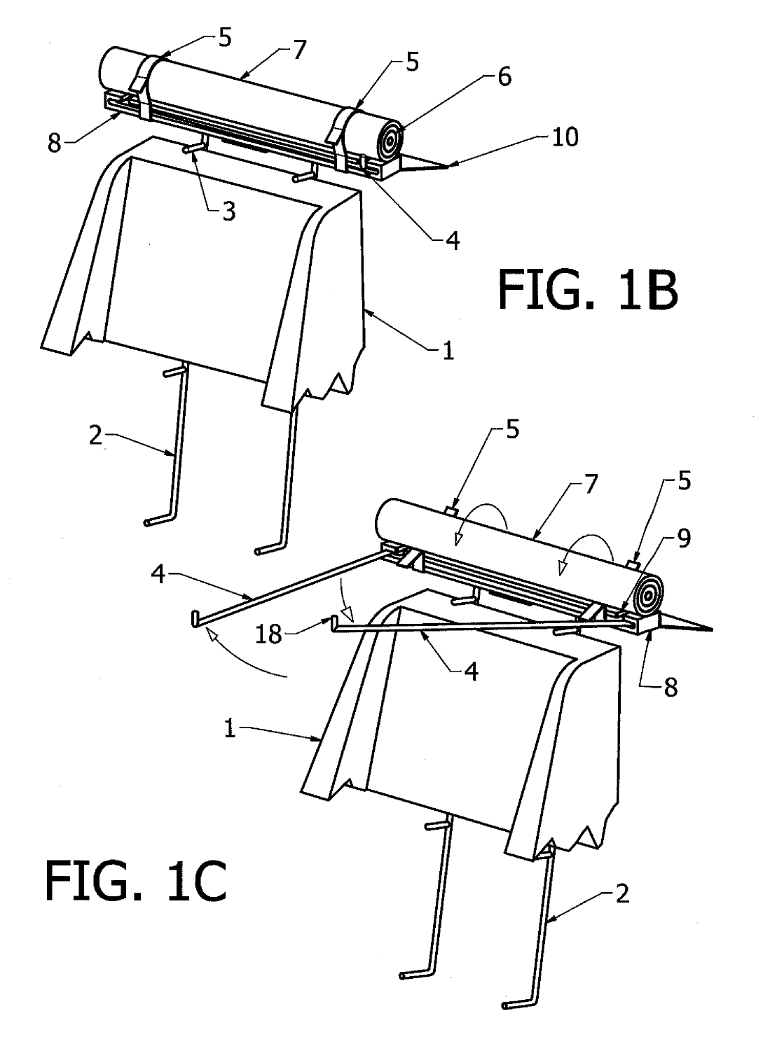

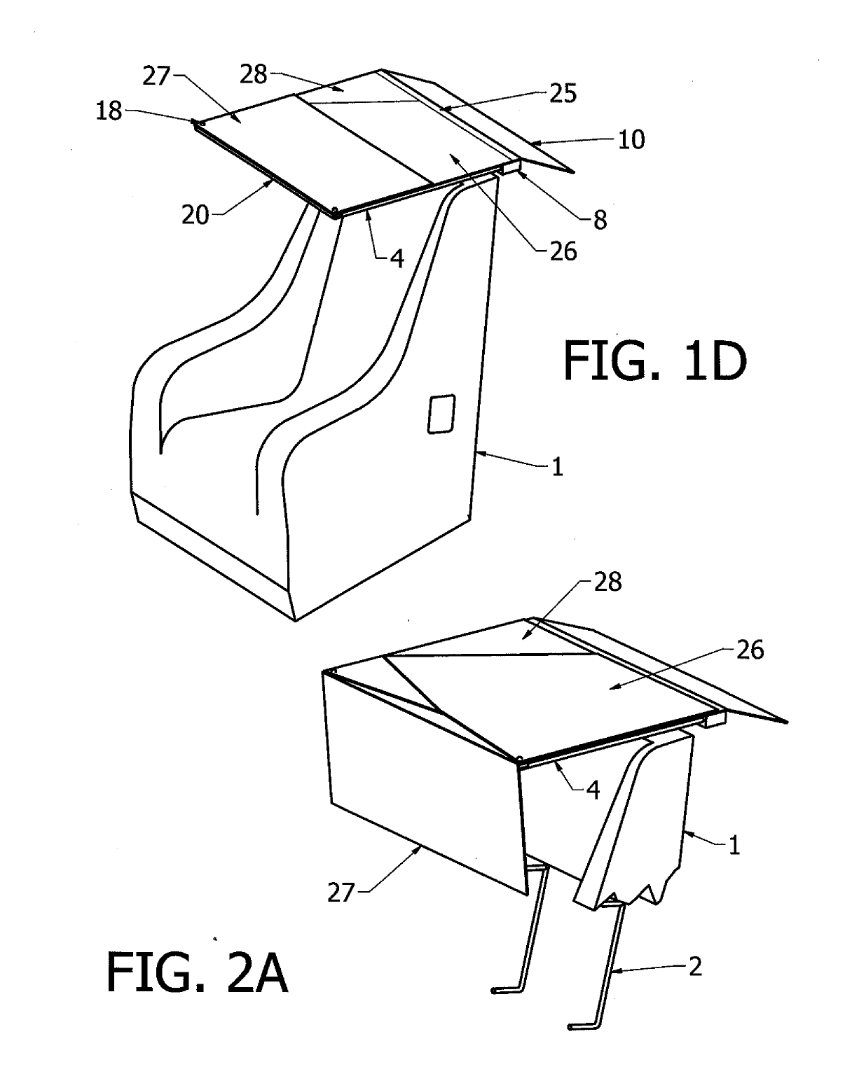

FIG. 1A, shows the general assembly of the sunshade with its sun-vent cover, 12, in its fully open position, and also with its zipper front shade panel, 24, and its two long side zipper panels, 22 and 23, it there down and open position.

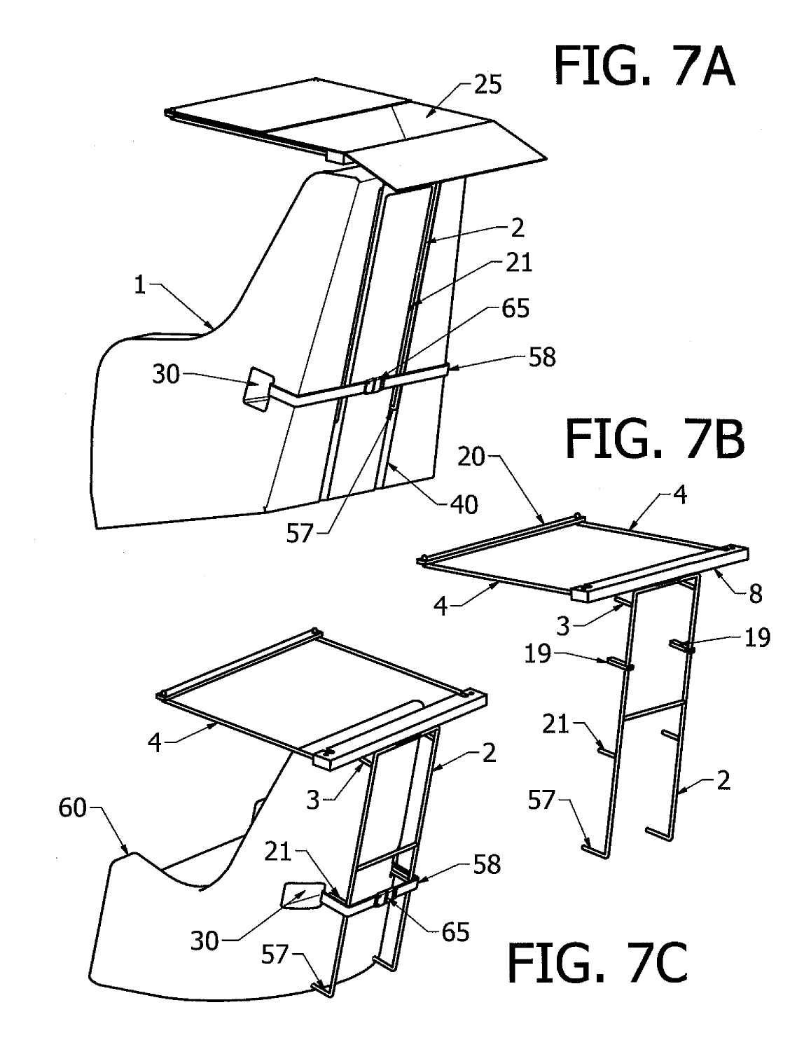

FIG. 1B, shows an isometric view of the sunshade in its rolled up and retracted position. The sunshade comprises of its support frame, 2, being placed behind and resting on the car seat, 1, with its support fingers, 3. The arm block, 8, is connected to the top of the support frame, 2, as seen in FIG. 7B. Seen here the two support arms, 4, are stored away inside of the arm block, 8. Two tie straps, 5, fixed to the arm block, 8, tie around it and the rolled up sunshade, 7, thus holding it fixed in place. The rear shade panel, 10, is stretched out behind in order to stop the sun from entering the sunshade from the rear of the vehicle.

FIG. 1C, is the same as in FIG. 1B, except the two tie straps, 5, are now open and the two support arms, 4, are free to be rotated outwards to a perpendicular position in with respect to the arm block, 8. These support arms, 4, are accessible by placing ones finger on the exposed arm fingers, 18, in which project above the finger slot, 9, as seen in FIG. 1B.

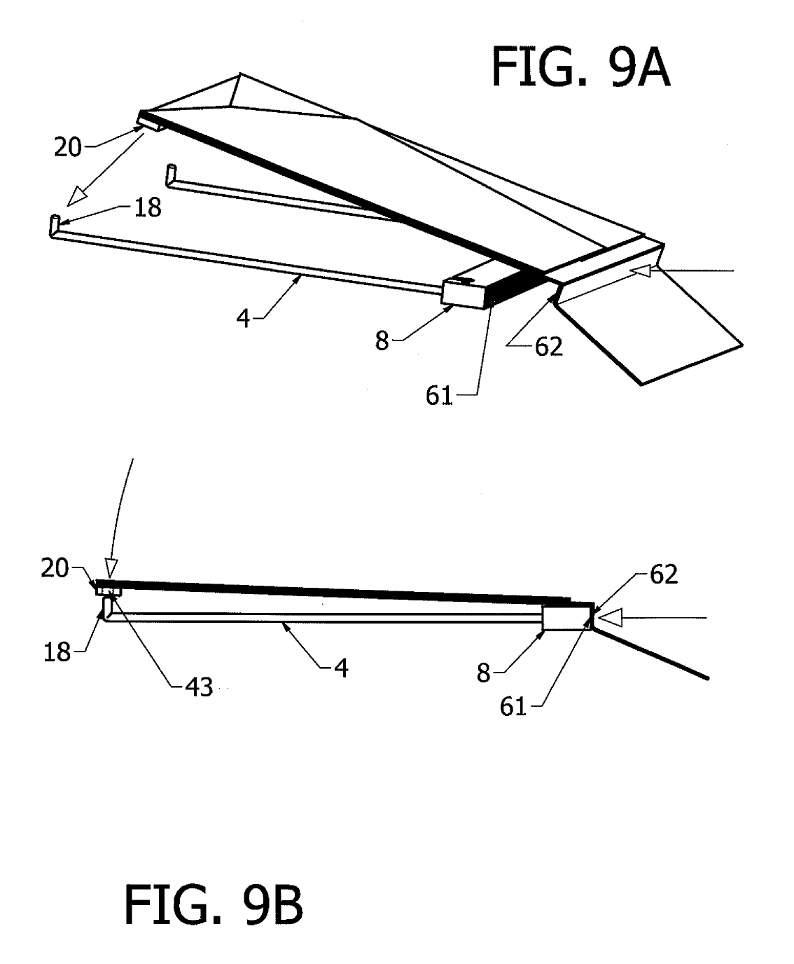

FIG. 1D, is the continuation of FIG. 1C, with it's two support arms, 4, fully extend outwards, and with the sunshade rolled out over these support arms, 4. The cross bar, 20, fixed to the top shade panel, 25, as shown in FIG. 9A, is place down and over the two arm fingers 18. The front shade panel, 27, and the two long side shade panels, 26 and 28, are folded on top of the top shade panel, 25, as shown. This configuration is used to protect the child from the sunrays from the top and back of the vehicle.

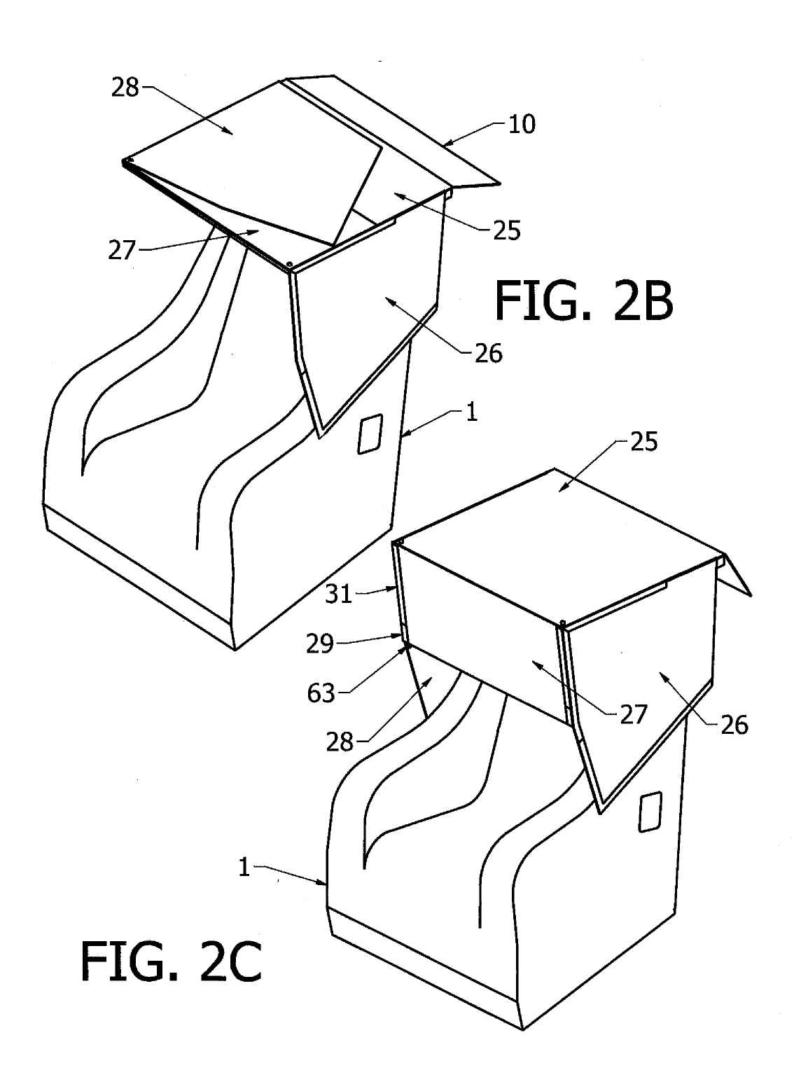

FIG. 2A, is similar to FIG. 1C but with the front shade panel, 27, in its down protecting position. This orientation is used for blocking the sunrays from the front of the vehicle.

FIG. 2B, is the same as FIG. 1C, with the exception of the R.H. long side shade panel, 26, in its down position.

FIG. 2C, here showing the entire sunshade with its front shade panel, 27, and its two long side shade panels, 26 and 28, in it's down positions. The two long side shade panels, 26 and 28, are attached to the front shade panel 22 for added rigidity by a hook tape, 29, and a side loop tape, 63. Any other common attachment method could be used like snaps, zippers, ties etc.

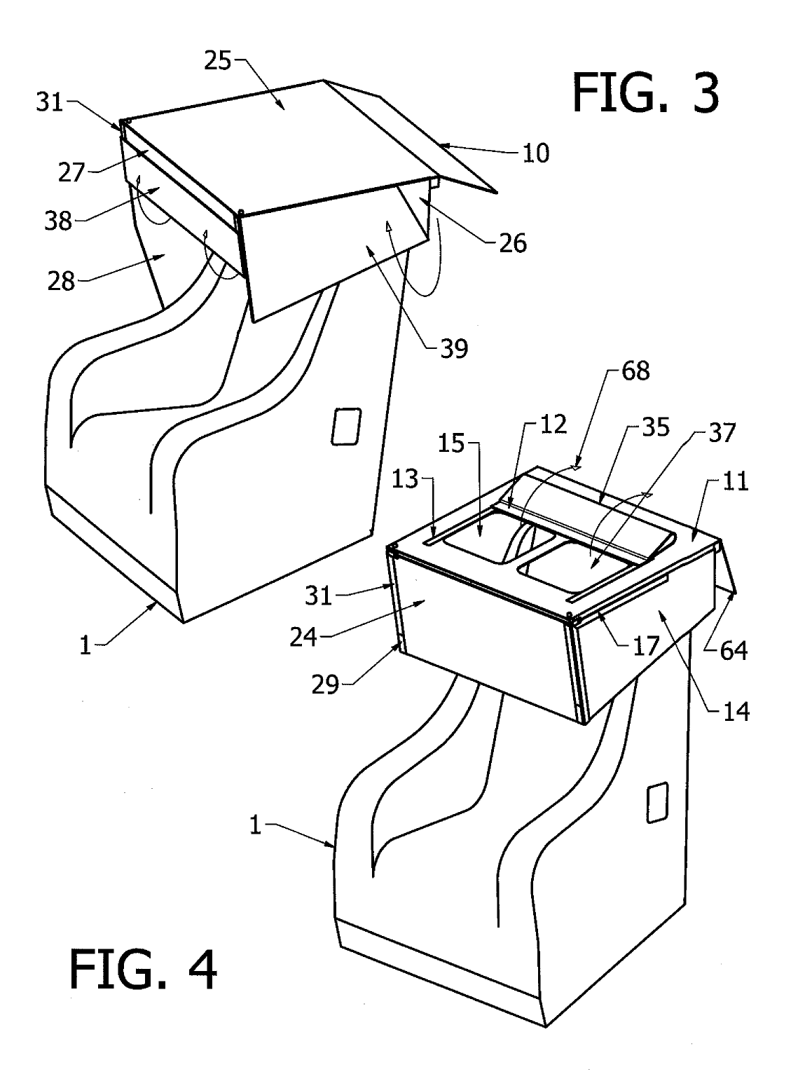

FIG. 3, is the same as FIG. 2C, but with its front shade panel, 27, folded upwards on to itself. It's held in this position by the use of the front hook tape, 29, and loop tape, 31, as seen in FIG. 4, attaching to each other.

The height and position of this front folded up panel, 38, is variable depending on where one decides to connect the front hook tape, 29, and the loop tape, 31, together. Also here shown is the R.H. long side shade panel, 26, shown with its side half way folded up onto its self. This side folded up panel, 39, is held up by the use of hook and loop tape. Please note that any other common attaching method could also be used like snaps, ties, zippers and etc.

FIG. 4, shows another version of a zipper detachable panel sunshade. Here there is a top panel, 11, and it's rear shade panel, 64, in which is made out of a 100% sun block material, but could also be made out of any other type of material. The 100% sun block material is used here to maximize the top and rear sunray protection. The top panel, 11, rolls out and attaches to the two support arms, 4, as shown in FIG. 1C. There are two top vent holes, 37, to allow maximum top ventilation, 68, and to allow the child be able to visually view upwards outside. The top vent opening, 37, is adjusted by sliding backwards and forwards the sun-vent cover, 12, over it. Here shown is the sun-vent cover, 12, in its full open position with the fold over, 35, at the back. The vent adjust strips, 13, are used to secure the sun-vent cover, 12, in any position over these sun-vent holes, 37. This type of sunshade has a zipper front shade panel, 24, and two short zipper side shade panels, 14 and 15. These panels can easily be removed and changed for different fabric materials to increase or to decrease the sunshade blocking abilities. All these panels do fold half way up as shown in FIG. 3, and can be folded on top of the top panel, 11, and rolled, retracted as shown in FIG. 1A.

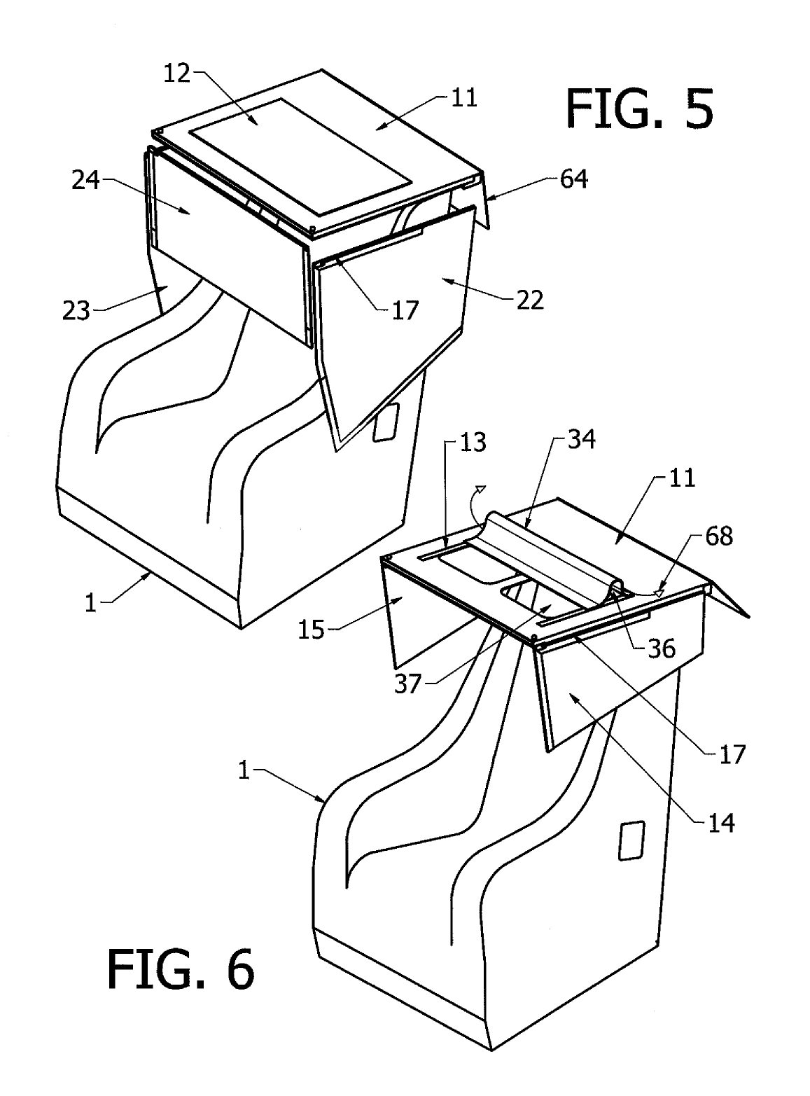

FIG. 5, shows how the zipper front panel 24, and the two long side zipper panels, 22, and 23, are removable and changeable like the short zipper side panels, 14 and 15, shown in FIG. 4. Also shown here is the top panel, 12, in its closed position.

FIG. 6, shows the zipper detachable panel sunshade as in FIG. 4, but with its zipper front shade panel, 24, removed. Also the sun-vent cover, 12, is part way open, allowing ventilation, 68, and top visibility through the top vent holes, 37.

Also with the sun-vent cover, 12, in this position, there is a vent side opening, 36, on both sides of the sun-vent cover, 12. This increases the inside air flow and ventilation from the front of this sun shade, removing any hot air from around the child and passing it out through both vent side openings, 36.

FIG. 7A, shows an isometric rear view of FIG. 1C. Here you can see how the support frame, 2, is attached and secured to the car seat, 1. An attachment strap, 58, is passed through the existing seat belt hole, 30, with in the car seat, 1. It then passes over and around the outside of the support frame, 2. It's connected and tightened together with the buckle, 65. The support frame, 2, two guide pins, 21, and two bottom fingers, 57, are slipped into the several different existing vertical channels, 40, moulded into the back of the car seat, 1.

FIG. 7B, shows the support frame, 2, assembly. There are two vertical adjustable height adjust fingers, 19, the arm block, 8, fixed on top, and the two fold out support arms, 4, being held open by the cross arm, 20.

FIG. 7C, shows a rear isometric view of the sunshade support frame, 2, mounted to the back of curved back car seat, 60. Since there are no vertical channels, 40, in this seat and its back surface is curved, the support frame, 2, will use its two guide pins, 21, and bottom fingers, 57, to rest against this curved surface. The two support legs, 3, will also help stabilize the support frame, 2. The attachment strap, 58, will wrap around the curve back car seat, 60, through its seat belt hole, 30, around the support frame, 2, and tightly connected with its buckle, 65. Both the bottom fingers, 57, and the guide pins, 21, will compensate for any curved or irregular surface.

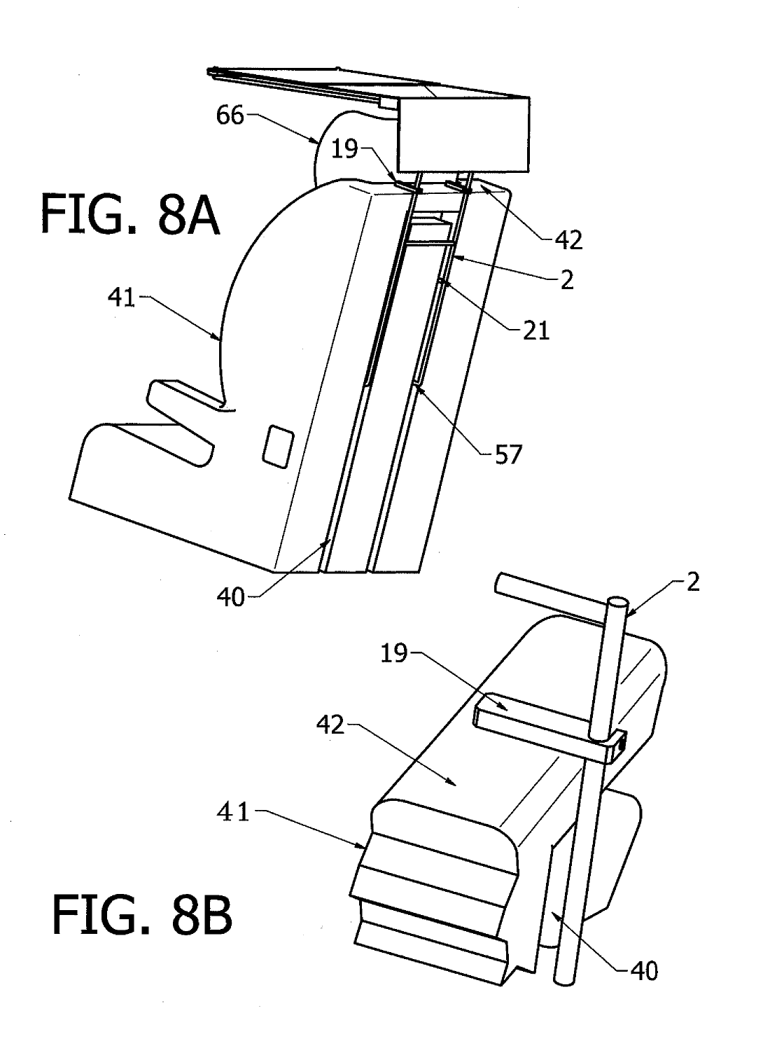

FIG. 8A, shows a pictorial rear view of a typical high booster seat, 41. Here you can see the support frame, 2, with in the high booster seats, 41, vertical channels, 40. The height of the support frame, 2, is adjustable by rising or lowering the position of the height adjust fingers, 19.

These fingers will rest on the car seat top, 42. As you raise or lower the headrest, 66, you can also adjust the height of the support frame, 2, as well.

FIG. 8B, is a close up of the height adjust finger, 19, as seen in FIG. 8A.

FIG. 9A, shows how the sunshade is attached to the support frame, 2. First of all, for just the first time, the support frame hook tape, 61, and the sunshade loop tape, 62, are attached together. Now the sunshade is fixed to the support frame, 2. Then you unroll the sunshade and pull outwards the cross bar, 20, positioning it over the two support arms, 4, and there arm fingers, 18.

FIG. 9B, shows a side view of FIG. 9A. Here you can see the cross bar, 20, being lowered vertically over and onto the both arm fingers, 18. The arm fingers, 18, then pass through the two arm finger holes, 43, with in the cross bar, 20.

FIG. 10, shows another method of securing the cross bar, 20, to the sunshade. Here shown is a sewn pocket, 67, apart of the sunshade. The cross bar, 20, is then slid into this sewn pocket, 67, then acts in the same manner as in FIG. 1C, with the connection between the cross bar, 20, and the two support arms, 4.

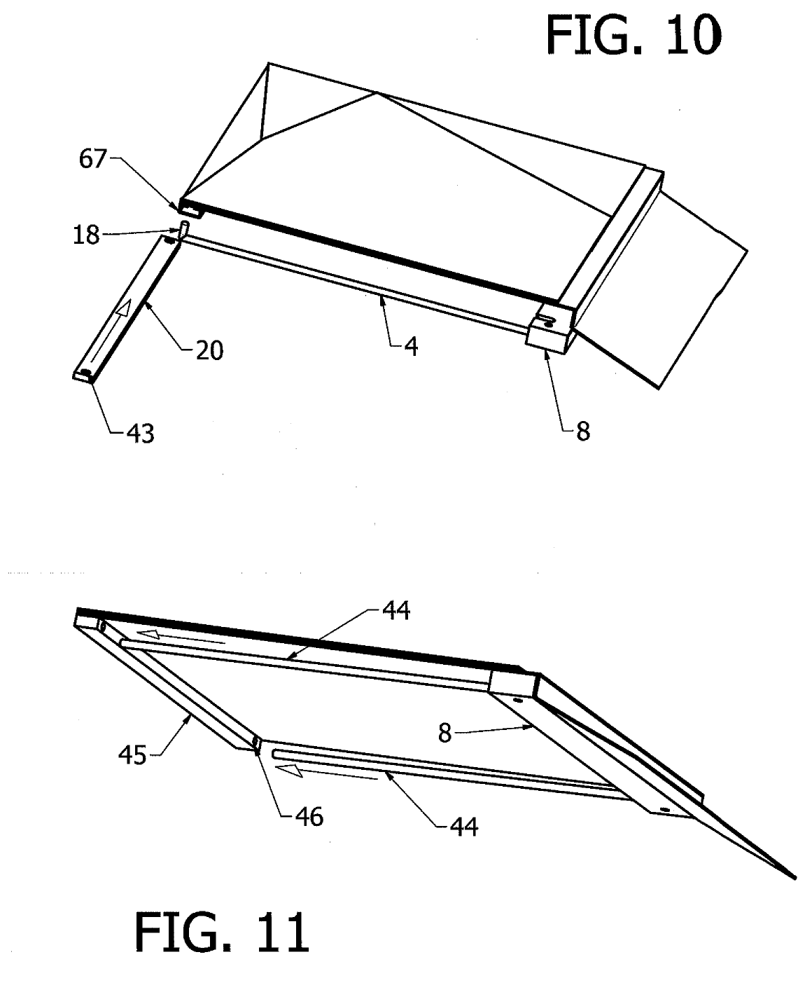

FIG. 11, is another version of connecting the front of the sunshade to the support frame, 2. A front bar, 45, incorporating two armholes, 46, will line up with the two straight arms, 44, ends, and then slide into each other forming a ridged connection.

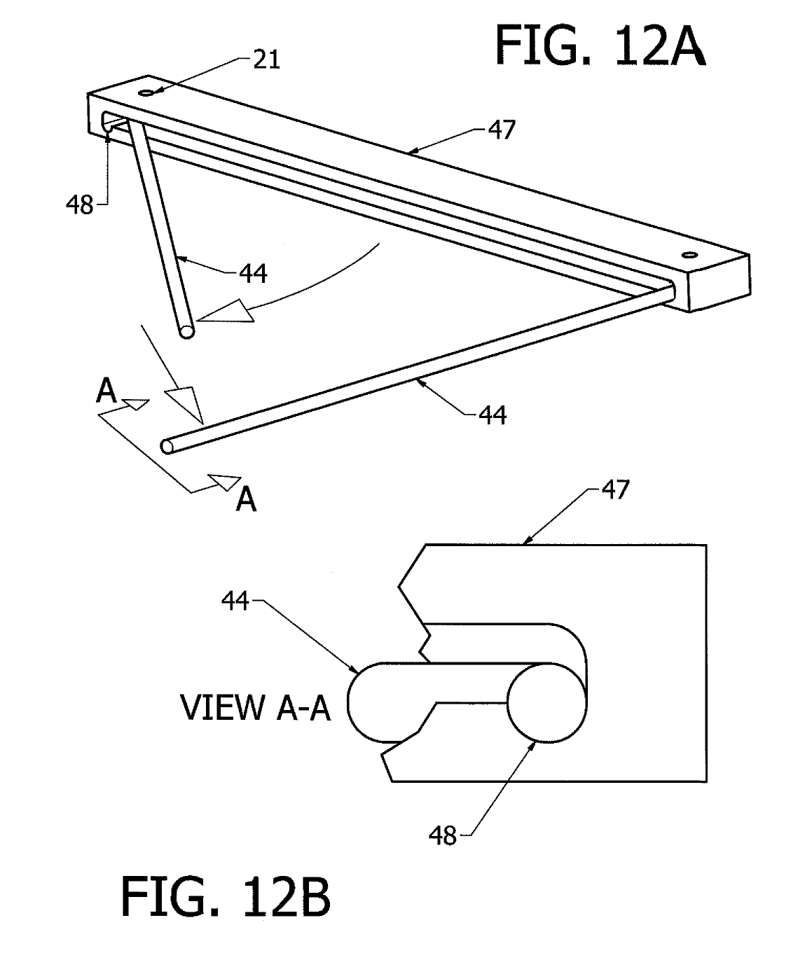

FIG. 12A, shows another way in which the support arms could be folded out and locked in position. Here shown is an arm block, 47, with its two straight arms, 44, folding inside of it. Once the straight arm, 44, are folded outwards 90 degrees to the arm block, 47, the straight arms, 44, will drop downwards, due to gravity into the machined out recess called the arm lock groove, 48. Once in this position, the straight, 44, will be captive in the sideway orientation.

However, the straight arm, 44, will still be able to be released by lifting it out of the arm lock groove, 48.

FIG. 12B, is a detail view of FIG. 12A, showing the straight arm, 44, in the arm lock groove, 48.

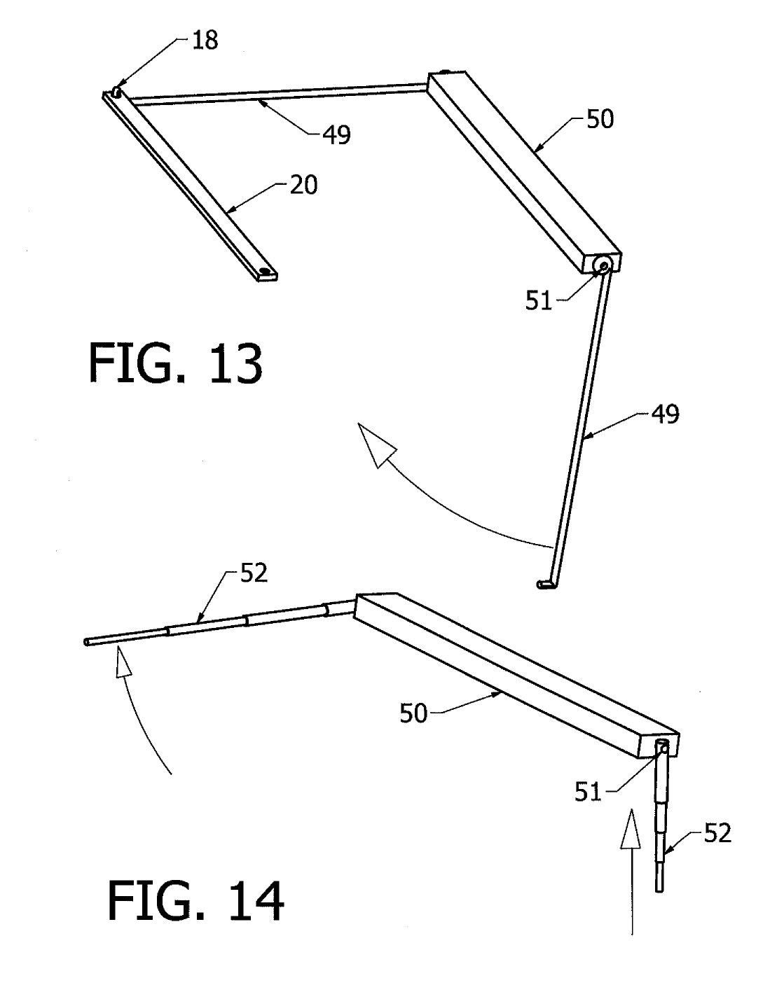

FIG. 13, is showing another way that the sunshade could be held in its open position. Here shown are two swing arms, 49, attached to the side of the swing arm block, 50, and pivoting around the arm pins, 51. When the sunshade is in the retracted position, the two swing arms, 49, will be vertically down, out of the way of the child or car seat, 1. These swing arms, 49, are then lifted upwards and locked there in order to roll out the sun shade for its open position.

FIG. 14, shows yet another way to hold open the sunshade. Here similar to FIG. 13, there are two pivoting telescoping arms, 52, in which function in the same manner as the swing arms, 49. However these telescoping arms, 52, can retract and extend, in order to occupy less space than the version in FIG. 13.

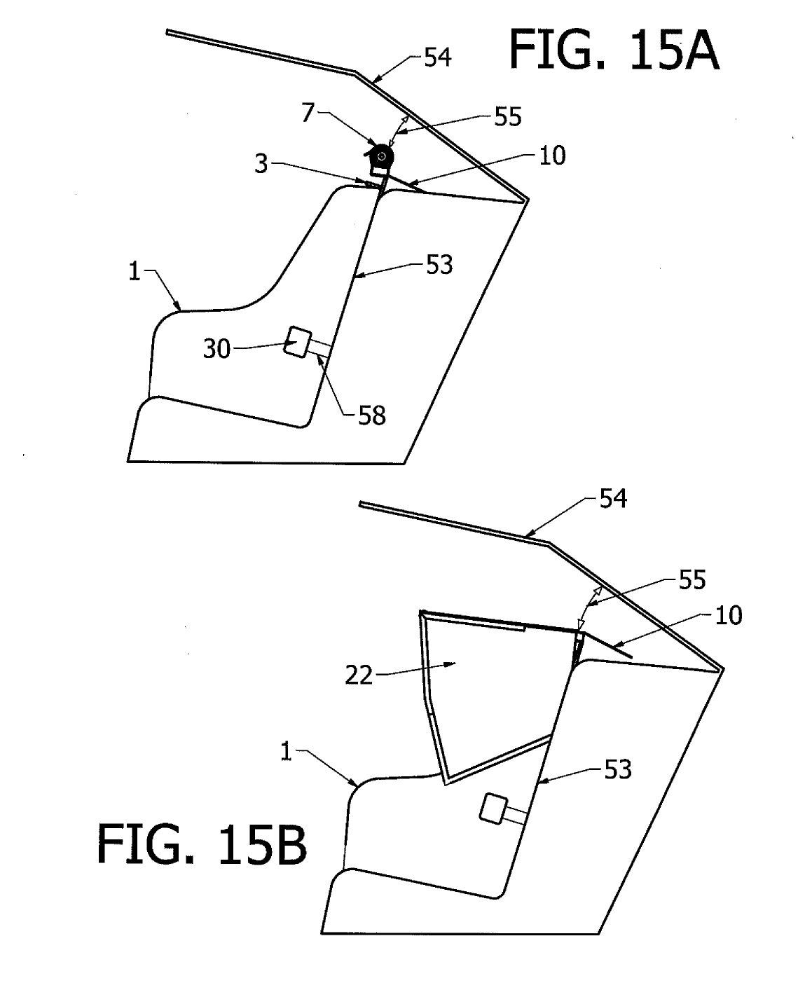

FIG. 15A, shows a section view of the car seat, 1, strapped into a typical rear seat, 53, of a car. The sunshade is in its retracted, folded up position. The rear shade panel, 10, is extended backwards. You can see the minimum seat to roof clearance, 55 existing.

FIG. 15B, is the same as in FIG. 15A, except the sunshade is in its open extended position. Still you can see the seat to roof clearance, 55.

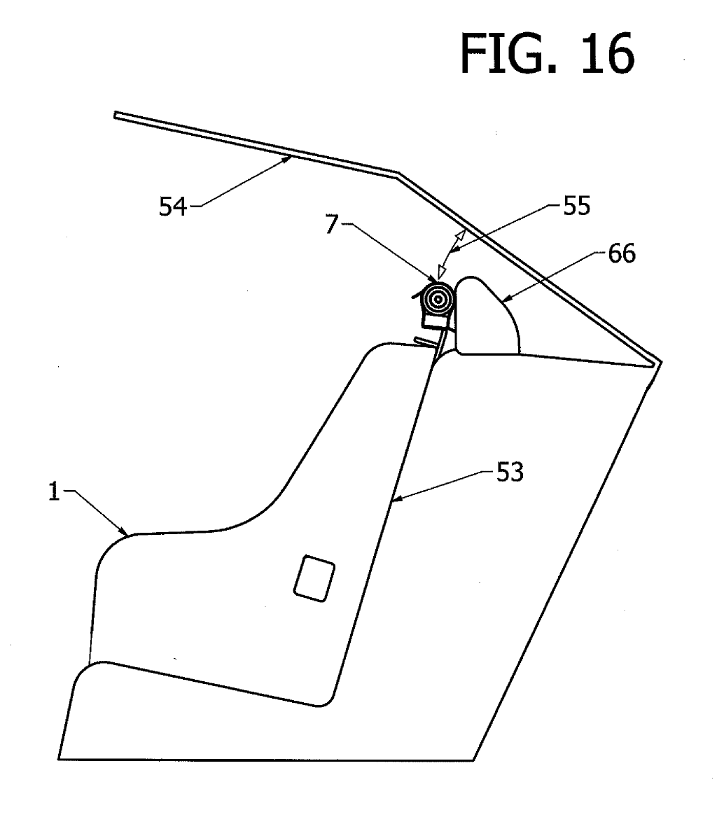

FIG. 16, is the same as in FIG. 15A, except here shown is a typical built in car rear seat headrest, 66. You can see how this rear seat head rest, 66, does not affect or have any bearing on the sun shade in its open or retracted position.

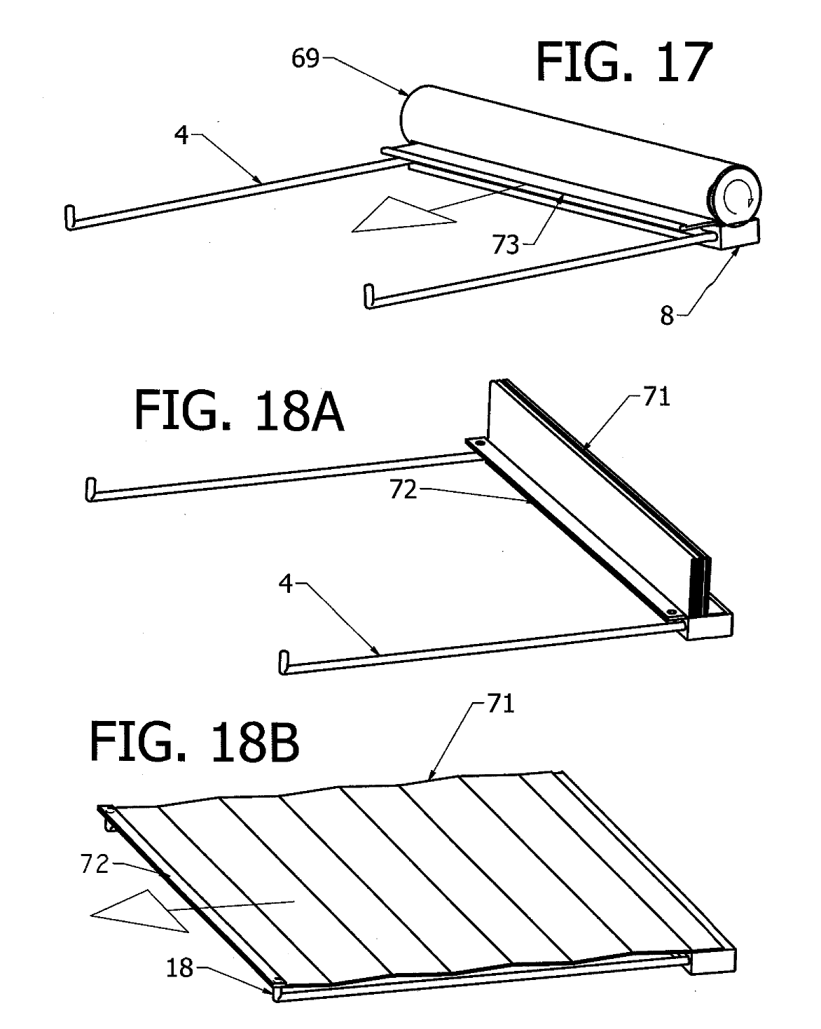

FIG. 17, shows another possible folding system for the sunshade. Here a spring loaded pull shade housing, 69, stores the sunshade in its retracted position. The pull sunshade housing, 69, is spring-loaded acting similar to a common house pull down blind. The shade pull tab, 73, is used to pull out the sunshade and to retract it back into its pull shade housing, 69.

FIG. 18A, shows another version to the sunshade. Here the sunshade, 71, is folded up and stacked onto its self in its retracted position. The shade pull tab, 72, remains exposed in its forward position.

FIG. 18B, is the same view as in FIG. 18A, except with the this sunshade, 71, extended over the support arms, 4, and connected to the two arm fingers, 18, on the end.

Please note that many other types of folding methods could be used that are not shown here, however the general concept and idea remains the same.

While the present invention has been described with reference to the above described preferred embodiments and alternate embodiments, it should be noted that various other embodiments and modifications may be made without departing from the spirit of the invention. Therefore, the embodiments described herein and the drawings appended hereto are merely illustrative of the features of the invention and should not be construed to be the only variants there of nor limited there to.

I claim:

1. A retractable and adaptable car seat sunshade comprising of:
a. a sunshade that is both fully extendable and retractable in which stores behind the child and remains fixed to the child's seat;
b. a sunshade that only attaches to the Childs seat and does not obstruct the drivers or passengers window views;
c. a sunshade when retracted, allows easy child placement and removal from their car seat or high booster seat with out removing or detaching the sunshade from said car seat;
d. an attachable frame to attach to any size or shape child car seat or high back booster seat;
e. this frame being adjustable in height to suite the different heights of children;
f. having retractable swing out support arms to support the top extendable sunshade cover;
g. a top extendable and retractable sun shade cover in which could be easily removed for cleaning;
h. a sunshade in which has fixed or removable sides and front sun blocking panels;
i. these panels being adjustable in height to better suite the child's sun screening needs;
j. a top retractable cover in which top ventilation can be controlled and also the child's overhead visibility;
k. a compact size sunshade in which minimises the drivers and passengers reduced rear window view;
l. these removable panels could be made of different colours, materials, shapes and sizes, and having different fabric openness factors.

2. A retractable car seat sunshade frame comprising of:
a. a frame in which attaches with just one strap to the back of most child car and high back booster seats;
b. a frame being sandwich between the child car seat and the vehicles rear seat back;
c. having fixed or adjustable guide pins or fingers on the vertical rods of the frame to brace it within the car seat slots and grooves and/or could rest firmly against the back of a contour child's car seat;
d. a frame with adjustable height fingers in which rest on the car seat back or surface in which can be slid up or down and locked in place to suite different car seat designs and children height requirements;
e. having a rolled up, retracted sunshade cover attaching to its frame arm block, behind the child's head;
f. it's size and shape not interfering with the vehicles rear seat and or with its built in head rests;
g. its retracted small size does not hindering the child's entry or removal from its car or high back booster seat;
h. an arm block in which is fixed to the top portion of the frame, this arm block houses the two support arms and where the sunshade fabric is fixed by a Velcro strip, hooks or snaps for easy removal;
i. two straps wrapping around the rolled sunshade cover, thus holding it and the two retractable support arms firmly in place;
j. it having two retractable and extending support arms in which in its retracted position, they both are folded into the arm block of the frame, or they could be extended forward 90 degrees to support the overhead sunshade fabric;
k. these support arms being secured in place in its retracted position in its arm block;
l. these support arms being held in place, in its open and extended position by a cross bar attached to the end of the extended sunshade cover;
m. these support arms being held in place, in its open and extended position by a cross bar sliding into a pocket on the end of the extended sunshade cover;
n. these support arms being held in its open position by their rods falling into a groove with in the arm block, thus holding them in place;
o. these support arms could be pivoted vertically, folded out, or extended telescopically from the arm block.

3. A retractable sunshade comprising of:
a. a roll out material cover in which rolls and stores in behind the child on top of the frame;
b. a cover fitted to the frame and rolls out and attaches to the extended ends of the support arms;
c. a cover with side and front panels in which can be fixed or removed in any combination;
d. these panels being infinitely adjustable in height in order to increase or decrease the child's sun protection and visibility;
e. the side panels being able to be folded over onto itself for doubling the sun block protection for the child at eye level;
f. removable panels in which can be attached by a zipper, Velcro, hinge, snaps or any other commonly used attachment method;
g. the option of just using the top roll out sunshade and no side panels for just the overhead protection;
h. the sunshade over all open size being small in area, thus giving the driver and passengers maximum window view;
i. these panels be interchanged with other panels of different shape and sizes;
j. these panels being made from different colour and material fabrics with different hole openness factors to increase or to decrease the child's sun protection;
k. having an adjustable top cover opening panel, in order to control the top cover ventilation, to vary the top sun protection, and the child's top visibility;
l. having its rear cover panel adjustable and open at the bottom to allow for an air flow with in the sunshade from the front to the back;
m. a front cross bar mounted to the front of the sunshade, to attach it to the two frame support arms in its open position;
n. this sunshade retracting and extending by folding in sections onto itself;
o. this sunshade extending and retracting with a spring wind mechanism, similar to a common window blind.
